(19) United States
(12) Patent Application Publication
(10) Pub. No.: US 2026/0201633 A1
(43) Pub. Date: Jul. 16, 2026

(54) THERMOREGULATIVE TEXTILES AND METHODS OF MAKING THERMOREGULATIVE TEXTILES

(71) Applicant: THE UAB RESEARCH FOUNDATION, BIRMINGHAM, AL (US)

(72) Inventors: Vinoy Thomas, Hoover, AL (US); Renjith Rajan Pillai, Birmingham, AL (US); Claudiu T. Lungu, Birmingham, AL (US)

(21) Appl. No.: 19/449,936

(22) Filed: Jan. 15, 2026

Related U.S. Application Data
(60) Provisional application No. 63/745,391, filed on Jan. 15, 2025.

(51) Int. Cl. D06M 10/02; B32B 5/02; B32B 5/26; D01D 5/00; D06M 10/06; D06M 101/06; D06M 101/32

(52) U.S. Cl. CPC D06M 10/025; B32B 5/02; B32B 5/022; B32B 5/265; D01D 5/0038; D01D 5/0084; D06M 10/06; B32B 2250/20; B32B 2262/0223; B32B 2262/04; B32B 2262/062; B32B 2262/16; B32B 2264/1021; B32B 2264/1022; B32B 2264/107; B32B 2264/301; B32B 2264/302; B32B 2307/416; B32B 2307/7265; B32B 2437/00; D06M 2101/06; D06M 2101/32; D06M 2200/10; D06M 2200/25; D10B 2331/04; D10B 2501/00

(57) ABSTRACT

The present disclosure provides for textiles and methods of making textiles. In an aspect, the textiles are thermos-regulative textiles.

### CROSS-REFERENCE TO RELATED APPLICATIONS

This application claims the benefit of and priority to U.S. Provisional Application Ser. No. 63/745,391, filed Jan. 15, 2025, having the title “THERMOREGULATIVE TEXTILES AND METHODS OF MAKING THERMOREGULATIVE TEXTILES,” the contents of which is hereby incorporated by reference in its entirety.

### STATEMENT REGARDING FEDERALLY SPONSORED RESEARCH OR DEVELOPMENT

This invention was made with government support under Grant Numbers T42OH008436 and P42-ES027723, awarded by the National Institute of Health and under Grant Number OIA-2148653, awarded by National Science Foundation. The government has certain rights in the invention.

### BACKGROUND

A rapid increase in atmospheric temperature has been reported in recent years worldwide. The lack of proper aid to protect from exposure to the sun during working hours raised the number of sunburn cases among workers. It is important to promote productive workplaces without compromising safety and health concerns.

### SUMMARY

Embodiments of the present disclosure provide for textiles and methods of making textiles.

The present disclosure provides for a textile, comprising: an oxygen plasma-pretreated fabric substrate having a first pre-treated side of the fabric substrate, wherein the oxygen plasma-pretreated fabric substrate includes a layer of nanofibers and silicon oxide nanoparticles, optionally wherein the nanofibers include nanoparticles and a polymer. In an aspect, the layer of nanofibers is disposed directly onto the first pre-treated side of the fabric substrate and the silicon oxide nanoparticles are on the layer of nanofibers or in another embodiment, the order can be switched. A second substrate can be disposed so that the layer of nanofibers and silicon oxide nanoparticles are between the first substrate and the second substrate.

The present disclosure provides for a method of making a textile, comprising: pretreating a fabric substrate with a low-temperature plasma to form an oxygen plasma-pretreated fabric substrate, wherein the oxygen plasma-pretreated fabric substrate has a first pre-treated side of the fabric substrate, wherein the low-temperature plasma is at a temperature of about 25 to 35° C.; electrospinning a nanofiber onto the surface of the first pre-treated side of the fabric substrate to form a layer of nanofibers, wherein the nanofibers include boron nitride nanoparticles and a polymer; and treating the first pre-treated side of the fabric substrate to form the layer of nanofibers with a tetraethoxy orthosilicate (TEOS), tetra methoxy silane, amino propyl silane, or tetra methyl silane or hydroxymethyl silane plasma to form silicon oxide nanoparticles on the layer of nanofibers. In an aspect, the order of the electrospinning step and the treating plasma step are switched. In an aspect, the electrospinning is one of AC electrospinning, DC electrospinning, Force-spinning, melt electrospinning, or solution electrospinning.

### BRIEF DESCRIPTION OF DRAWINGS

Further aspects of the present disclosure will be more readily appreciated upon review of the detailed description of its various embodiments, described below, when taken in conjunction with the accompanying drawings.

FIG. 1.1 illustrates thermal regulation of the BN-PET-SI Fabric according to various embodiments of the present disclosure.

FIG. 1.2 illustrates a schematic representation of surface decoration of fabric substrate with boron nitride nanoparticles (BNNps) and silicon oxide nanoparticles (SiNps) using electrospinning and plasma surface modification techniques according to various embodiments of the present disclosure.

FIG. 1.3A illustrates a schematic representation of electrospinning according to various embodiments of the present disclosure.

FIGS. 1.3B and 1.3C depict solutions according to various embodiments of the present disclosure. FIG. 1.3B illustrates the PET solution in HFIP. FIG. 1.3C illustrates the BN-PET.

FIGS. 1.3D-J depict the fabric according to various embodiments of the present disclosure. FIG. 1.3D illustrates pristine fabric. FIG. 1.3E illustrates BN-PET ES-coated fabric. FIG. 1.3F illustrates water-soaked BN-PET ES-coated fabric. FIG. 1.3G illustrates water-soaked-dried BN-PET ES-coated fabric. FIG. 1.3H illustrates oxygen plasma pretreated BN-PET ES-coated fabric. FIG. 1.3I illustrates oxygen plasma pretreated water-soaked BN-PET ES-coated fabric. FIG. 1.3J illustrates oxygen plasma pretreated water-soaked-dried BN-PET ES-coated fabric.

FIG. 1.3K illustrates possible interactions of the plasmas with the substrate according to various embodiments of the present disclosure.

FIGS. 1.4A-B depict SEM images of spin-coated BNNps according to various embodiments of the present disclosure.

FIGS. 1.4C-D depict SEM images of SiNps deposited via plasma surface treatment according to various embodiments of the present disclosure.

FIG. 1.4E depicts SEM image of BNNps according to various embodiments of the present disclosure.

FIG. 1.4F illustrates BNNps diameter distribution in a histogram according to various embodiments of the present disclosure.

FIGS. 1.5A-P depict high and low resolution SEM images according to various embodiments of the present disclosure. FIGS. 1.5A and 1.5E depict SEM images of pristine fabric. FIGS. 1.5B and 1.5l depict SEM images of BN-PET ES-S1 fabric. FIG. 1.5C depicts an SEM image of BN-PET ES-S1 and TEOS plasma treated fabric. FIGS. 1.5D and 1.5K depict SEM images of water-soaked-dried BN-PET ES-S1 and TEOS plasma treated fabric. FIGS. 1.5F and 1.5J depict SEM images of oxygen plasma-pretreated BN-PET ES-S1 fabric. FIG. 1.5G depicts a SEM image of oxygen plasma-pretreated BN-PET ES-S1 and TEOS plasma treated fabric. FIGS. 1.5H and 1.5L depict SEM images of oxygen plasma-pretreated water-soaked-dried BN-PET ES-S1 and TEOS plasma treated fabric. FIGS. 1.5M and 1.5N depict SEM images of oxygen plasma-pretreated BN-PET ES-S2 fabric. FIG. 1.50 depicts a SEM image of oxygen plasma-pretreated BN-PET ES-S2 and TEOS plasma treated fabric. FIG. 1.5P depicts a SEM water-soaked-dried BN-PET ES-S2 and TEOS plasma treated.

FIGS. 1.6A-M illustrate thermal imaging according to various embodiments of the present disclosure. FIG. 6A illustrates a schematic representation of the thermal imaging. FIG. 6B depicts a thermal camera image of pristine fabric. FIG. 1.6C depicts a thermal camera image of BN-PET ES-S1 fabric. FIG. 1.6D depicts a thermal camera image of BN-PET ES-S1 and TEOS plasma treated fabric. FIG. 1.6E depicts a thermal camera image of water-soaked-dried BN-PET ES-S1 and TEOS plasma treated fabric. FIG. 1.6F depicts a thermal camera image of oxygen plasma-pretreated fabric. FIG. 1.6G depicts a thermal camera image of oxygen plasma-pretreated BN-PET ES-S1 fabric. FIG. 1.6H depicts a thermal camera image of oxygen plasma-pretreated BN-PET ES-S1 and TEOS plasma treated fabric. FIG. 1.6I depicts a thermal camera image of oxygen plasma-pretreated water-soaked-dried BN-PET ES-S1 and TEOS plasma treated fabric. FIG. 1.6J depicts a thermal camera image of oxygen plasma-pretreated fabric. FIG. 1.6K depicts a thermal camera image of oxygen plasma-pretreated BN-PET ES-S2 fabric. FIG. 1.6L depicts a thermal camera image of oxygen plasma-pretreated BN-PET ES-S2 and TEOS plasma treated fabric. FIG. 1.6M depicts a thermal camera image of oxygen plasma-pretreated water-soaked-dried BN-PET ES-S2 and TEOS plasma treated fabric.

FIGS. 1.7A-D illustrate samples for optical microspectroscopic analysis. FIG. 1.7A depicts a microscope glass plate with 3 samples: (a) pristine glass slide, (b) BN-PET ES-S2 for 30 seconds, and (c) BN-PET ES-2S for 30 seconds and TEOS plasma treated for 8 minutes. FIG. 7B illustrates the normalized transmittance versus wavelength plot for the thick coating. FIG. 1.7C depicts a microscope glass plate with 3 samples: (a) pristine glass slide, (b) BN-PET ES-S2 for 15 seconds, and (c) BN-PET ES-S2 for 15 seconds and TEOs plasma treated for 5 minutes. FIG. 1.7D illustrates the normalized transmittance versus wavelength plot for the thin coating.

FIGS. 1.8A-H illustrates high-resolution spectra of SI in oxygen plasma-pretreated BN-PET ES-S2 and TEOS plasma treated fabric according to various embodiments of the present disclosure.

FIG. 2.1 illustrates Keyence microscopic 3D images of the ES BN-PET on the fabric surface to check the coating thickness.

FIGS. 3.1A-3.1C illustrate SEM images of polymer fibers formed with silica and boron-nitride nanoparticles at various percentages.

FIGS. 3.2A-3.2B illustrate SEM images of polymer fibers formed with titania and boron-nitride nanoparticles at various percentages.

FIG. 3.3 illustrates a table of the fiber diameter dimensions of the various fiber compositions.

FIG. 3.4 illustrates a table of the heat capacity of the various fiber compositions.

FIGS. 3.5A and 3.5B illustrates a table of the thermal conductivity of the various fiber compositions.

### DETAILED DESCRIPTION

The present disclosure provides for textiles and methods of making textiles. In an aspect, the textiles are thermo-regulative textiles.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the patent disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of textiles, chemistry, material science, and the like, which are within the skill of the art.

The following examples are put forth so as to provide those of ordinary skill in the art with a complete disclosure and description of how to perform the methods and use the compositions, methods, and materials disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

As used herein, the following terms have the meanings ascribed to them unless specified otherwise. In this disclosure, “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

As used herein, a “textile” may be defined as a material manufactured from fibers, filaments, or yarns characterized by flexibility, fineness, and a high ratio of length to thickness. Textiles generally fall into two categories. The first category includes textiles produced directly from webs of filaments or fibers by randomly interlocking to construct non-woven fabrics and felts. The second category includes textiles formed through a mechanical manipulation of yarn, thereby producing a woven fabric, a knitted fabric, a braided fabric, a crocheted fabric, and the like. The textile of the present disclosure may be a woven, braided, crocheted, knit, or nonwoven textile. In an aspect, the textile can be an article of apparel (e.g., a shirt, a jersey, pants, shorts, a glove, a sock, a hat, a cap, a jacket, helmet, or an undergarment) or an article of footwear

As used herein, “water-resistant” in reference to a textile means that textile is substantially impervious to water. In some exemplary aspects, the term “water-resistant” may be defined as a textile or fabric that has greater than 1,000 mm of water resistance, which is the amount of water (in mm) that can be suspended above the textile or fabric before water seeps into the textile or fabric. In an aspect, the coatings of the present disclosure have the characteristic to remain stable in water, which allows for the textiles including the coating to be washed and retain their characteristics (e.g., thermo-regulatory characteristic).

As used herein, “infrared (IR) reflective” in reference to a textile (refers to the fabric's ability to reflect a significant portion of infrared radiation, particularly in the wavelength of about 700 nm to 2500 nm. This characteristic reduces heat absorption by the textile, contributing to improved thermal regulation and comfort. To quantify the IR reflectivity of a textile, a light extinction spectrophotometer can be used to measure the percentage of IR radiation extincted by the material. The test involves directing a beam of infrared light onto the textile surface and measuring the intensity of reflected light across the specified wavelength range.

The present disclosure provides for textiles and methods of making textiles. In an aspect, the textiles are thermos-regulative textiles. The present disclosure provides for methods to modify an existing textile (e.g., adding a coating), such as fabrics, to achieve thermal regulation properties and optionally water-resistant properties. Other methods use wet-chemical methods to produce textiles with achieve thermal regulation properties. The present disclosure provides for a non-wet process that retains the bulk properties of the textile (e.g., fabric). Other approaches use specially designed fibers or yarns to achieve thermal regulative properties, whereas the present disclosure can use any type of fiber or yarn, which is more cost effective. Additional details are provided in Examples 1-3.

In an aspect, the textile can be IR reflective. In an aspect, the textile can be 10 to 20° C. or about 15° C. cooler than an untreated textile exposed to the same IR rays. In the experimental evaluation, to demonstrate the efficiency of the treated fabric in mitigating thermal radiation, a thermal source set to 45° C. was used, reflecting the maximum temperature typically observed during the hot season over a year. In an aspect, measurements revealed that the treated fabric's effective temperature was approximately 15° C. cooler than the untreated fabric under the same conditions. The effective temperature was measured on the inner side of the fabric to more accurately assess the coating's ability to mitigate IR radiation through mechanisms such as reflection, refraction, and scattering. Specifically, with exposure to the 45° C. thermal source, the inner surface temperature of the treated fabric was recorded at approximately 20° C., compared to 36° C. for the untreated fabric. In an aspect, the coating disposed on the textile exhibits water stability. In a particular aspect, evaluating the coating's durability may be important, as the fabric is designed for wearable applications and requires occasional washing between uses, even if infrequent. Factors to be considered include the coating's adhesion to the fabric surface and its ability to retain thermo-regulative functionality after washing. Experimental results confirmed that the coating remains stable on the fabric surface and maintains its thermoregulatory properties, showing no degradation when exposed to water or after washing.

In an aspect, the present disclosure provides for a textile that has thermal regulation properties. The textile can include a fabric substrate, where the fabric substrate is an oxygen plasma-pretreated fabric substrate. The oxygen plasma-pretreated fabric substrate has at least a first pre-treated side of the fabric substrate. The oxygen plasma-pretreated fabric substrate includes a coating having a layer of nanomaterial (e.g., nanofibers or nanofiber/nanoparticles) and silicon oxide nanoparticles. In an aspect, the layer can comprise the nanomaterial (e.g., nanofibers or nanofiber/nanoparticles) and silicon oxide nanoparticles. In an aspect, the layer can consist essentially of nanomaterial (e.g., nanofibers or nanofiber/nanoparticles) and silicon oxide nanoparticles, where these components are the active components to achieve the desired thermoregulatory properties and water resistance. In an aspect, the layer of nanomaterial is disposed on the first pre-treated side of the fabric substrate and then a layer of silicon oxide nanoparticles is disposed on the layer of nanomaterial. In an aspect, some of the silicon oxide nanoparticles can be disposed onto the first pre-treated side of the fabric substrate. In another aspect, the silicon oxide nanoparticles are disposed on the first pre-treated side of the fabric substrate and then the layer of nanomaterials are disposed onto the silicon oxide nanoparticles and the first pre-treated side of the fabric substrate

In an aspect, the nanomaterial can include nanofibers and/or nanofibers with nanoparticles. The nanofibers can includes polymer such as polyethylene terephthalate (PET), polyamide (e.g., nylon), polytetrafluoroethylene (e.g., Teflon), polyvinylpyrrolidone (PVP), hydroxylpropyl cellulose (HPC), cotton, polyurethanes, polyesters, combinations of these, derivatives of any one of these, or other similar textile materials. In an aspect, the fibers can be formed using electrospinning. The nanofibers including nanoparticles can include the polymer described above and herein along with boron nitride nanoparticles, silica, titania or glass micro-balloons. In a particular aspect, a combination of PVP and HPC can be used (1:2, 2:1 or 1:1 ratio). The layer of nanomaterial can have a thickness of about 100 nm to 1 μm. In particular, the layer of nanofibers can have a thickness of about 100 nm to 1 μm. The nanofibers can have a diameter of about 100 nanometers to 1 micron and a length of several centimeters or an aspect ratio of about 100 to 1000. Quantification of the weight of the nanofibers can be challenging; however, the thickness of the nanofiber layer can be about 50 and 80 μm.

The nanoparticles that are included in the nanofiber can include boron nitride nanoparticles, silica, titania or glass micro-balloons and these nanoparticles can have a diameter of about 50 nm to 1000 nm or about 1 to 3 microns. In particular, the boron nitride nanoparticles can have a diameter of about 50 nm to 1000 nm or about 1 to 3 microns. In an aspect, the boron nitride nanoparticles can have diameters of about 50 to 100 nm, with TEM data indicating that the majority of the particles are about 50-60 nm.

In an aspect, the nanoparticle layer can include a mixture of nanoparticles. For example, the mixture can include silicon oxide and boron nitride nanoparticles, where the amount of nanoparticles that are boron nitride nanoparticles is about 5 to 20% or 6 to 18% while the silica are about 80 to 95% or about 82 to 94%. In another example, the mixture can include titania and boron nitride nanoparticles, where the amount of nanoparticles that are boron nitride nanoparticles is about 5 to 20% or 6 to 18% while the titania are about 80 to 95% or about 82 to 94%.

The silicon oxide nanoparticles can be formed using plasma such as a tetraethoxy orthosilicate (TEOS), tetra methoxy silane, amino propyl silane or tetra methyl silane or hydroxymethyl silane plasma, which can form a layer of silicon oxide nanoparticles. In an aspect, the silicon oxide nanoparticles can have a diameter of about 1 to 10,000 nm, about 1 to 1000 nm, about 10 to 500 nm, or about 10 to 100 nm.

In an aspect, the textile can have a “sandwich” structure, where the layer of nanofibers and the silicon oxide nanoparticles are between two textiles structures. For example, the textile can include an oxygen plasma-pretreated fabric substrate and a second substrate. The second substrate can be disposed onto the layer of nanofibers and silicon oxide nanoparticles so that layer of nanofibers and silicon oxide nanoparticles is positioned between the oxygen plasma-pretreated fabric substrate and the second substrate. In this embodiment, the layer of nanofibers and the silicon oxide nanoparticles can be protected and have a longer effective lifetime.

The present disclosure provides for methods of making textiles as described herein. In an aspect, the present disclosure provides for a method of making a textile that includes pretreating a fabric substrate with a low-temperature plasma to form an oxygen plasma-pretreated fabric substrate. The oxygen plasma-pretreated fabric substrate has a first pre-treated side of the fabric substrate. The low-temperature plasma is at a temperature of about 25 to 35° C. or about 30° C. and for about 5 to 15 minutes or about 10 minutes. The low-temperature plasma treatment roughens the surface of the fabric and increases the surface energy of the surface, which is conducive to better bonding of the nanofibers to the surface of the fabric relative to a surface that is not pretreated. In an aspect, the plasma chamber pressure is maintained at about 500-100 m Torr to start providing the radiofrequency power to initiate the plasma using oxygen as the precursor.

After pretreating the surface of the fabric, a layer of nanofibers can be electrospun onto the surface of the first pre-treated side of the fabric substrate to form a layer of nanofibers. The nanofibers are the same as those described above and herein. With the surface of the fabric pretreated, the nanofibers adhere to the surface of the fabric, which allows for the textile to be worn and washed for repeat use.

Next, the first pre-treated side of the fabric substrate including the layer of nanofibers can be treated with a plasma treatment (e.g., a tetraethoxy orthosilicate (TEOS) plasma) to form silicon oxide nanoparticles on the layer of nanofibers. The treatment can be for about 5 to 15 minutes or about 10 minutes. Optionally, another fabric can be disposed on the layer of nanofibers and silicon oxide nanoparticles. The other fabric can be a separate fabric or part of the original fabric that is folded over onto itself (e.g. without the layer of nanofibers and silicon oxide nanoparticles).

In another aspect, the first pre-treated side of the fabric substrate can be treated with the plasma treatment to form the silicon nanoparticles prior to electrospinning fibers. In this method, the layer of silicon nanoparticles and the fibers is reversed. Optionally, another fabric can be disposed on the layer of nanofibers and silicon oxide nanoparticles. The other fabric (e.g., which may be pretreated with a low-temperature plasma to form an oxygen plasma-pretreated fabric substrate) can be a separate fabric or part of the original fabric that is folder over onto itself (e.g. without the layer of nanofibers and silicon oxide nanoparticles).

Additional features about the method of making the textile are provided in Examples 1-3.

### EXAMPLES

### Example 1

A rapid increase in atmospheric temperature has been reported in recent years worldwide. The lack of proper aid to protect from exposure to the sun during working hours raised the number of sunburn cases among workers. It is important to promote productive workplaces without compromising safety and health concerns. In the present work, we report the low-temperature plasma (LTP) assisted tailoring of the surface properties of fabrics to reflect the IR radiation from the sun. The LTP technique can be adapted for thermally sensitive materials such as fabrics and textiles due to its lower working temperature range of 30° C. We have modified various substrates such as commercially available fabric, regular, and boron nitride incorporated electrospun PET surfaces with tetra ethoxy orthosilicate (TEOS) plasma. TEOS plasma treatment can deposit reactive plasma polymerized silane nanolayer on the surface of these substrates. The plasma-processed silane nanolayer was systematically characterized using Scanning Electron Microscopy (SEM), X-ray Photoelectron Spectroscopy (XPS), Keyence 3D-microscopic imaging, and Transmission Electron Microscopy (TEM). From the SEM and TEM data, the size of nanoparticles was observed in the range of 100-200 nm. The thermal regulation coating thickness was examined with the Keyence 3D imaging technique. The IR reflection potential of the surface was analyzed using a FLIR thermal imaging system. The data revealed that the plasma-modeled nano surface shows higher reflective potential toward IR rays, and it seems to be cooler than the unprocessed surface by approximately 15° C. The stability and efficiency of the plasma-modified electrospun nanolayer in water were satisfactorily examined with SEM and IR imaging. Taken together, these results suggest the excellent potential of this plasma processing to develop IR reflective coatings.

### 1. INTRODUCTION

Currently, problems with thermal regulation for personal thermal comfort have become conspicuous with the rapid increase in atmospheric temperature due to various factors and have been identified as one of the most urgent issues in this century. Most excitingly, 15% of the electric power consumption was globally derived from cooling systems for space cooling for buildings thereby targeting efficient personal cooling in the workspaces¹. Thermal comfort is a condition of mind which expresses satisfaction with the existing thermal environment². Thermal conditions can adversely affect physical and physiological health. In extreme cases, if the core body temperature reaches a condition of hyperthermia (above 37.5-38.3° C.) or hypothermia (below 35° C.), it can lead to potentially life-threatening conditions for humans³. Personal cooling technologies have attracted increasing attention and demand because of their ability to provide thermal comfort by localized thermal control for an individual in an efficient, low-cost way. The entire world is in a way of industrialization with due consideration to the environment from the experiences such as global warming and increased sunburn cases everywhere in the near past^{4 5}. The comprehensive analysis of sunburn cases in the United States in the last decades shows a drastic increase^{6 7}. This scenario necessitates the development of novel and promising strategies to ensure personal thermal comfort.

While considering the economic aspects, a lack of thermal comfort may be ended up in a declined economy due to reduced industrial labor productivity⁸. The shreds of evidence demonstrate the profound impact of climatic conditions on modern human societies' functioning with inconsistent economic activities^{9 10}. Personal thermal comfort is a major concern for outdoor workers because they are getting directly exposed to the sun. The current scenario demands thermal comfort for the employees for increased productivity, which leads to a huge economic burden on employers¹¹. The researchers were focused mostly on the thermal regulation and energy saving approaches for buildings^{12 13 14} but often not taken much measures for the personal thermal comfort of outdoor workers.

Herein, we proposed an effective and facile strategy for scalable thermal regulation coating on fabric materials. Instead of developing a new thermal regulative fabric material, we have developed a method to modify the existing fabrics to achieve thermal regulation properties. The proposed process is a dual-stage modification that includes electrospinning and plasma surface modification^{15 16}. The rationale behind choosing the electrospinning process was its ability to create non-woven nanofiber coating with scalable thickness, which was already reported for various applications^{17 18}. In this work, the ES nonwoven nanofibers of BN-incorporated PET (BN-PET) were laid on the fabric, ensuring a stable and uniform distribution of the BNNps. The selection of PET was due to its stability in water, spinnability, and material properties as a fabric^{19 20 21}. The surface decoration of the ES non-woven fibers with SiNps was achieved via low-temperature plasma (LTP) treatment that is viable for thermal-sensitive materials^{22 23}. The LTP-assisted formation of Si nanoparticles and their in-situ deposition on surfaces were reported²⁴. Both SiNps²⁵ and BNNps^{26 27 28} were known for their thermal reflective properties but were hardly ever used together to get an enhanced potential^{29 30 31 32 33}. In this proposed work, we used both the nanoparticles together and thereby achieved one of the highest thermal regulation potentials for a fabric. The SiNps and BNNps were already used for thermal regulation textile development by compositing with polymers^{34 33}. Mohamed et.al. developed the SiNps using multistep wet-chemical methods³⁵. But in the present work, we synthesized and deposited the SiNps in a single step-non-wet technique, the LTP processing, that could perform a uniform surface modification retaining the bulk properties unaffected on thermally sensitive materials^{36 37 38 39}.

### 2. RESULTS AND DISCUSSION

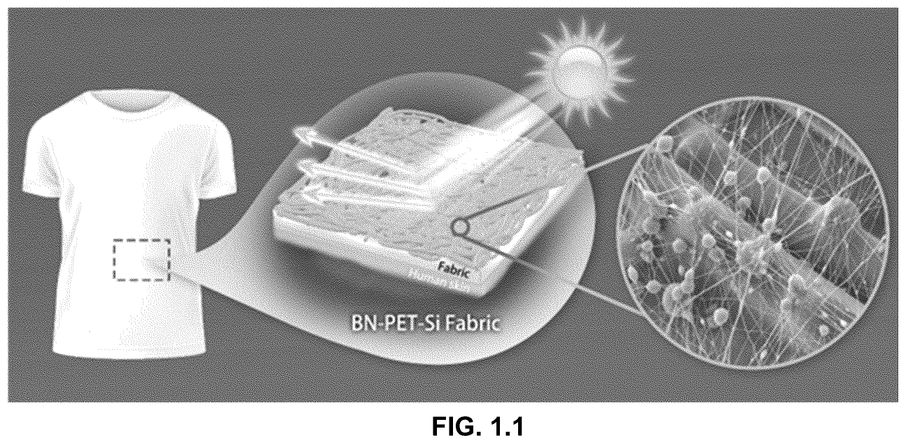

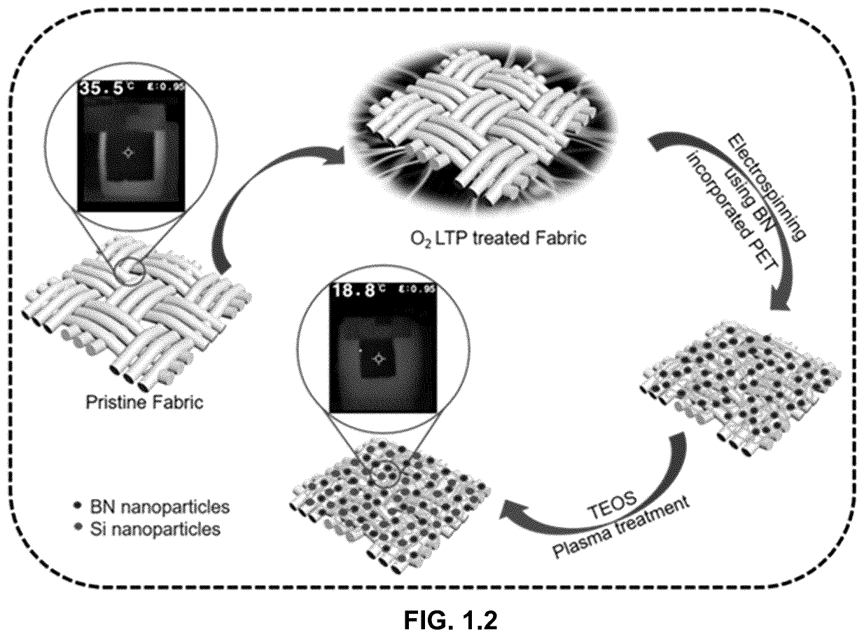

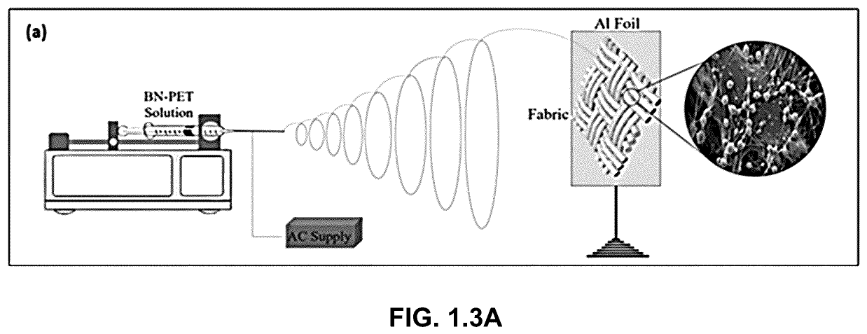

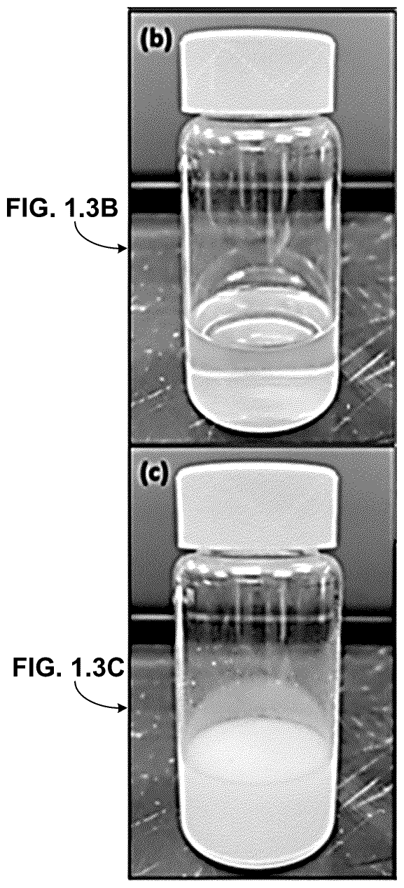

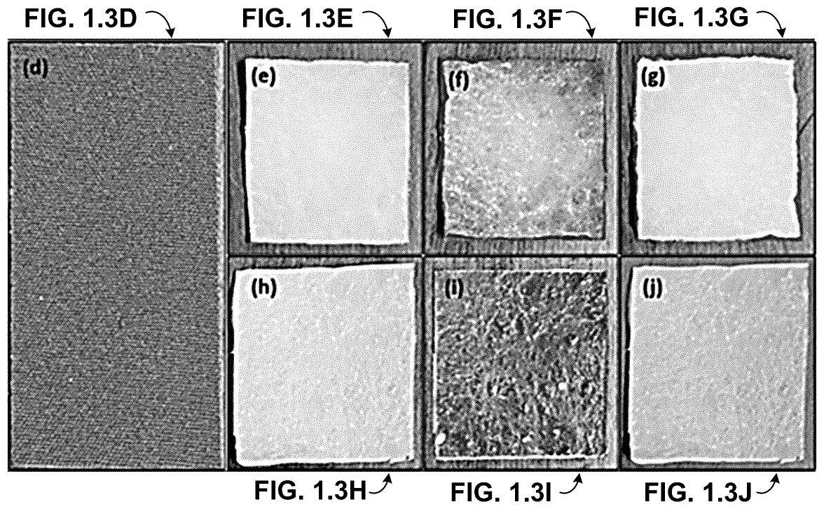

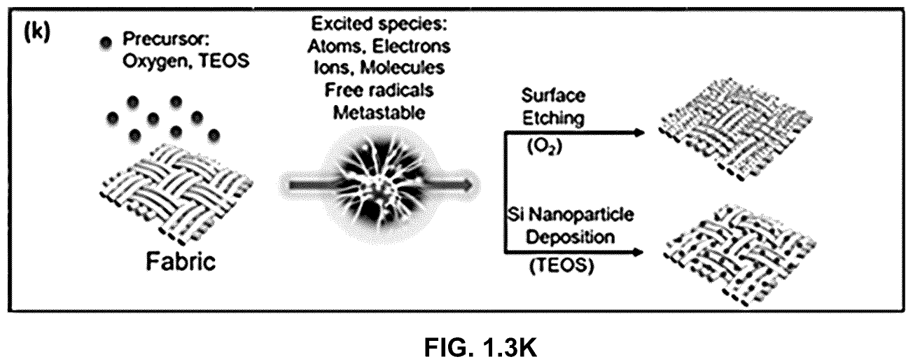

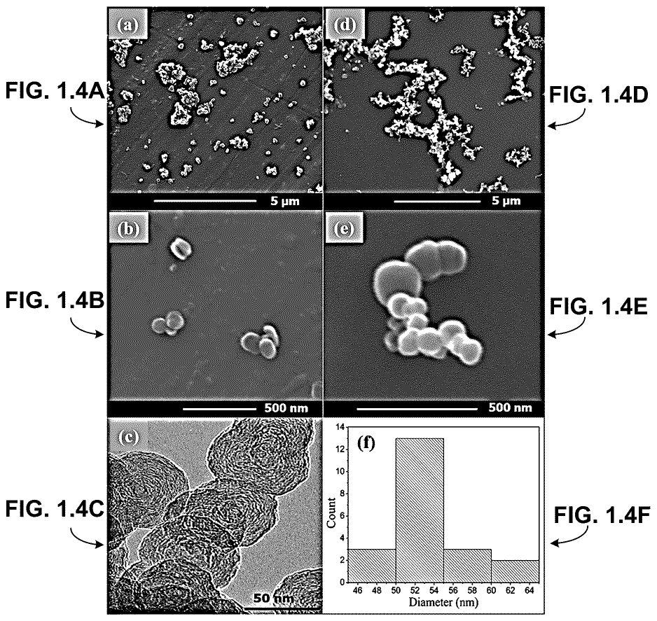

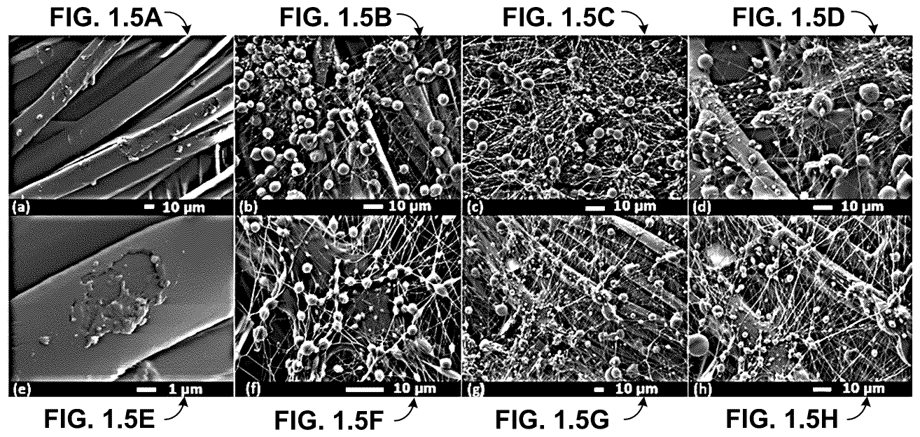

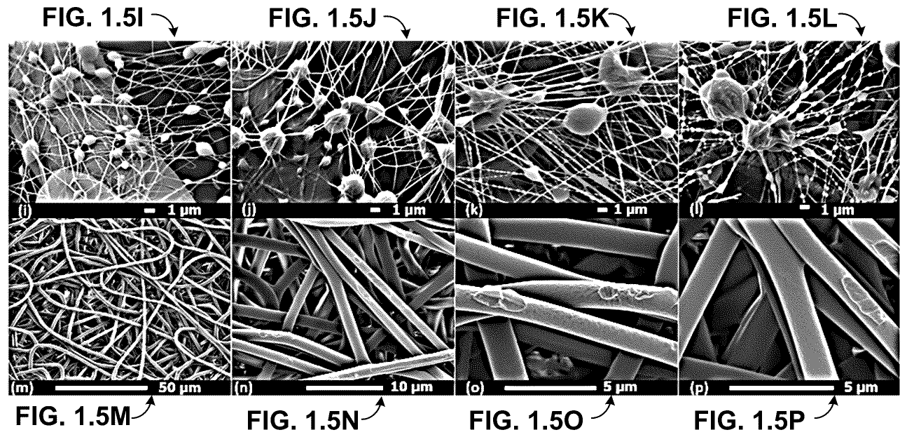

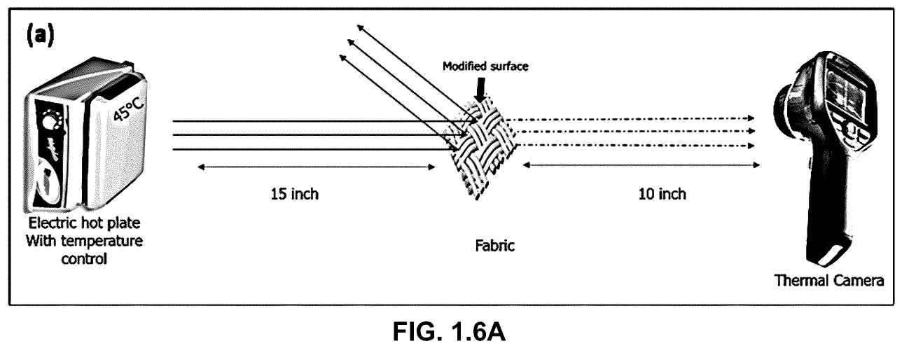

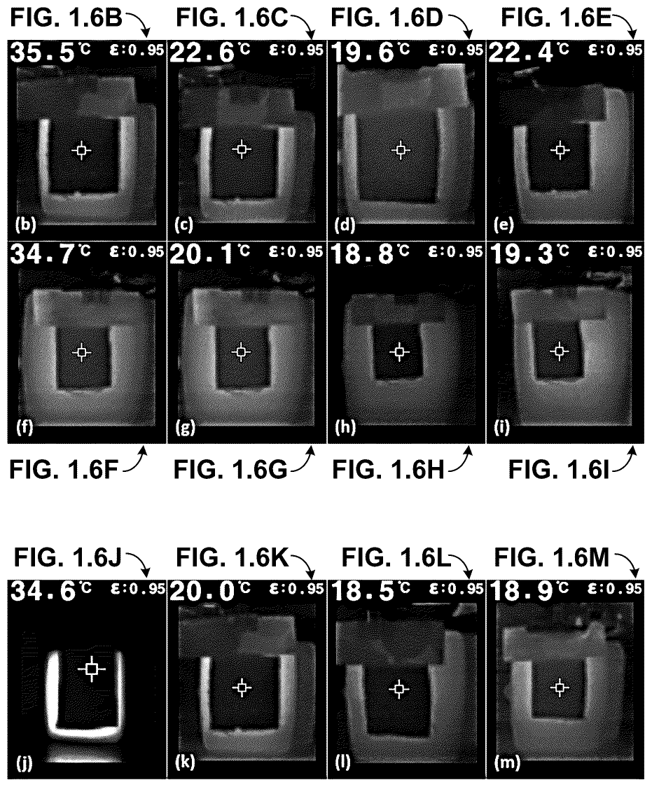

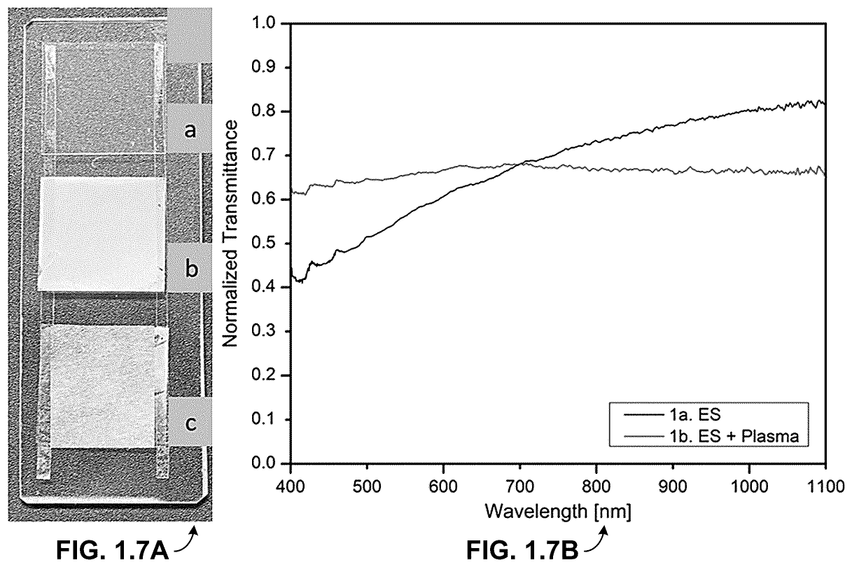

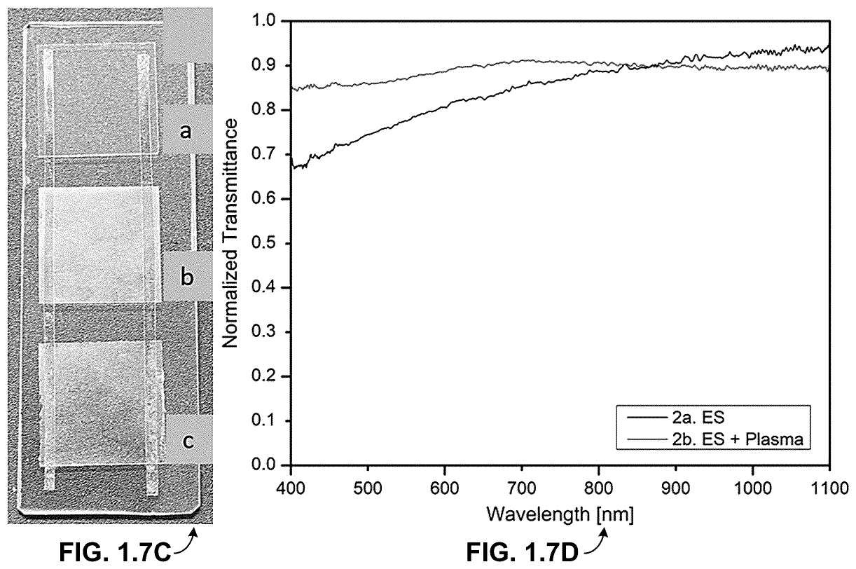

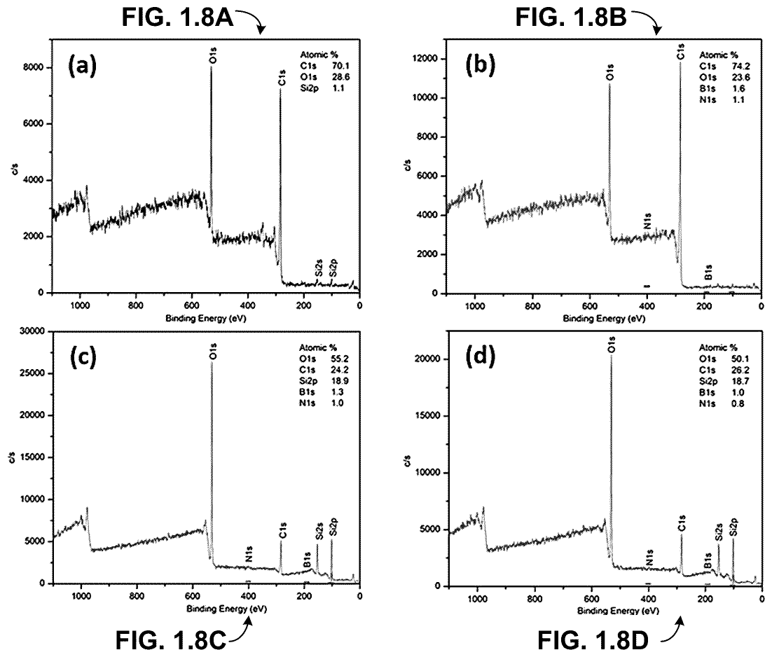

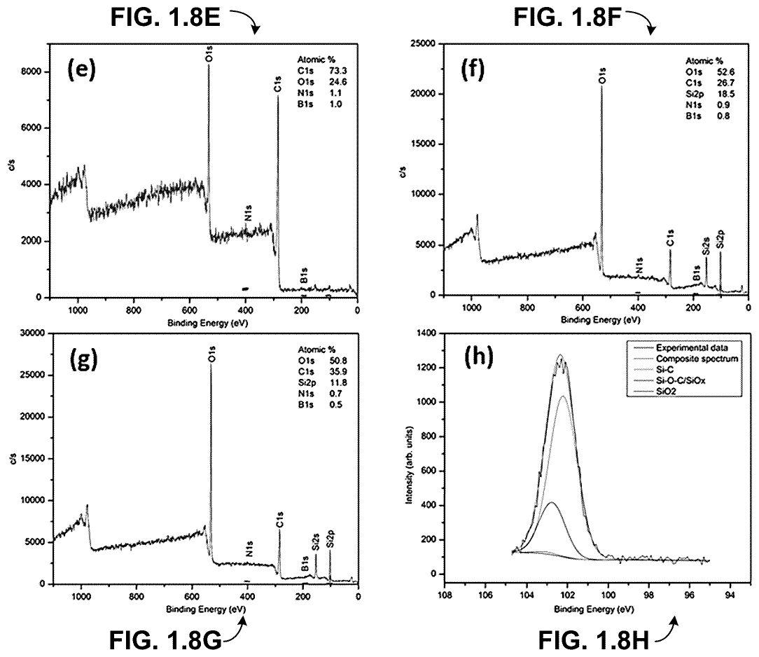

The proposed strategy combines two processes: plasma surface treatment and electrospinning. Plasma surface modification methodology is a facile way to activate or modify the substrate^{40 41 42 43}. More specifically, the fabric surfaces were activated with oxygen plasma pretreatment. Plasma surface modification can alter the surface roughness and surface energy, which are vital in offering better adhesion between the fabric substrate and the electrospun (ES) nanofiber layer. Plasma discharge parameters need to be optimized to get the desirable surface functionalities. We have deposited the electrospun nanofibers of BN-PET on pristine as well as oxygen plasma pretreated fabrics. The stability of both was examined in water. Since the substrate was modified with a focus on labor clothing application, stability in water needs to be optimum. Using electrospinning technology, non-woven nanofibers of BN-PET were deposited on the fabric surface. The ES non-woven fiber surfaces were further modified by depositing SiNps using TEOS plasma treatment. The substrate modification methodology was schematically summarized in FIG. 1.2.

The plasma-modified ES nanofiber-coated fabric was soaked in water for 45 seconds to ensure complete wetting and then subsequently dried. The oxygen plasma pretreated fabric offers better adhesion towards the ES fibers compared to the one without pretreatment, as seen in FIGS. 1.3G and 1.3J. This was due to the surface activation that happened via oxygen plasma treatment. Surface functionalization and surface etching are the most likely phenomenon to occur with oxygen plasma treatment^{44 45 46}. Oxygen plasma can furnish polar functional groups such as C═O, O—H, O═C—O, or even more uncommon groups⁴⁷ on the substrate surface. This could alter the surface energy of polymers and thereby introduce an enhanced surface adhesion toward the material to be deposited on the superficial layer^{48 49}. The surface free energy change of the fabric substrate with oxygen plasma treatment was calculated using contact angle measurements with glycerol and water as solvents. There were ~35-fold increase in the surface energy of the fabric with 10 minutes of oxygen plasma treatment. The oxygen plasma treatment has no significant effect on the water-withholding capacity of the fabric materials.

The BNNps dispersed in PET solution were imaged using SEM by spin coating the dispersion on a glass slide. The data revealed the presence of spherical clusters of BNNps on the surface with an average particle size of 100±20 nm (FIGS. 1.4A-B). TEM analysis corroborated the SEM data (FIG. 1.4C). The BNNps size distribution was examined and provided as a histogram. The LTP-assisted synthesis and in-situ deposition of SiNps were previously reported by our group²⁴. Using TEOS plasma, SiNps were deposited on a glass slide and characterized using SEM. The SiNps were more scattered on the substrate surface instead of forming clusters (FIGS. 1.4D-E). From the SEM data, the average particle size examined was 100±20 nm.

A very thin layer of nanofibers was deposited using 0.1 mL of 0.31% wt/wt BN/PET polymer solution (S1) and was characterized using SEM at various levels of modifications to examine the morphological changes. The SEM data conclusively states that the oxygen plasma pretreatment offers improved adhesion between ES non-woven nanofibers and the fabric surface. The ES nanofibers of BN-PET on the surface of the pristine fabric (FIG. 1.5B) seem to have poor attachment in comparison to the oxygen plasma pretreated fabric (FIG. 1.5F). The nanofibers were attached to the pretreated fabric with a cluster-centric spider-web-like network at different points (FIGS. 1.5F and 1.5J). But in pristine fabric, the non-woven nanofibers are laid on the fabric without any significant attachment. The coating instability in water (FIG. 1.3F) could be better justified by this. The non-woven nanofibers were furnished with SiNps via TEOS plasma processing. FIGS. 1.5D, 1.5H, 1.5K, and 1.5L clearly stated that the loss of BNNPs and SiNPs with water soaking was more from the TEOS plasma-modified ES nanofibers on pristine fabric than the oxygen plasma pretreated fabric. The process parameters including the solution viscosity could influence the fiber diameter and bead/cluster formation^{50 51 52 53}. An incontestable reproducibility was ensured via optimization of the electrospinning solution composition as 0.17% wt/wt BN/PET (S2) for cluster-free distribution of BNNps and 15% wt/vol PET/HFIP for stable ES nanofiber coating (FIGS. 1.5M-N). The coating stability and thermal regulation potential trend were maintained the same as that of the ES-S1 with oxygen plasma pretreated fabric. The thermal regulation and the thickness of the ES coating varied directly in proportion. So, electrospinning process parameters were optimized as a 1.5 mL solution spun-coated on a 25 cm² fabric sample at a rate of 1 mL/hr to maximize the coating stability and thermal regulation potential. The coating thickness was measured as 67.42±6.03 μm using the Keyence VHX-7000 High resolution 3D imaging system.

The fabric substrates at various levels of modifications were examined for their thermal regulation potential. A hot plate maintained at 40° C. was used as a source of heat to examine the thermal regulation potential using an IR imaging system. Arrangements of the heat source, fabric samples to be analyzed, and the thermal imaging camera were shown in FIG. 1.6A where the surrounding temperature was noted as 17.1° C. Each sample was imaged after 50 seconds of exposure to the heat source. The effective temperature got stabilized at or around 30 seconds of exposure. The pristine fabric experienced an effective temperature of 35.5° C., which was reduced to 22.6° C. with electrospun BN-PET (S1) nanofiber deposition and diminished further to 19.6° C. with TEOS plasma surface treatment (FIGS. 1.6B-D). With oxygen plasma pretreatment, the effective temperature of the fabric was reduced by ~1.0° C., and the BN-PET (S1) electrospun nanofibers brought it down to 20.1° C. The temperature further diminished to 18.8° C. with plasma-assisted deposition of SiNps (FIGS. 1.6F-H). One of the major issues to be examined in this case was the effect of washing on the thermal regulation potential of the coating. TEOS plasma-modified BN-PET ES (S1) fabric samples with and without oxygen plasma pretreatment were analyzed after water soaking and drying. The data revealed a significant loss in thermal regulation efficiency of the sample without pretreatment (reduced by 2.8° C.) and a negligible decrease in the sample with pretreatment (reduced by 0.5° C.) as in FIGS. 1.6E and 1.6I). Another set of samples with 15% wt/vol PET/HFIP and 0.17% wt/wt BN/PET (S2) was examined and was showing improved thermal regulation and stability in water than the coating made of S1. The ES nanofibers brought down the temperature from 34.6° C. to 20.0° C. and further improvement in thermal regulation was brought by the Si nanoparticles via TEOS plasma treatment. The effective temperature was analyzed as 18.5° C. As seen in the previous samples, the water soaking process had a negligible effect on the thermal regulation potential, which decreased by 0.6° C. The thermal imaging results were in good agreement with the SEM data. So, the S2 was conclusively chosen for better stability and scalability of the coating, and thermal regulation potential.

The thermal regulation potential of the plasma-modified ES coating on the fabric was characterized using white-light spectroscopy in the wavelength range of 400-1100 nm. Microscope glass plates were used as substrates for these transmission experiments and the pristine plate was used as the reference background for maximum light transmission (FIGS. 1.7A and 1.7C (a)) and BN-PET ES (FIGS. 1.7A and 1.7C (b)) and BN-PET ES with TEOS plasma (FIGS. 1.7A and 1.7C (c)) were chosen as samples. The decrease in transmitted light trend with the thickness of the coating was examined with variable duration for electrospinning such as 30 and 15 seconds as well as for plasma, 8 and 5 minutes respectively (FIGS. 1.7A-D). The data shows that both the thick and thin coating follows a similar extinction trend toward thermal radiation. The plasma process increases the extinction of light in the near-infrared (NIR) region (700-1100 nm), which is responsible to cause more heating and have more health effects, increased with TEOS plasma treatment on the ES nanofibers. The normalized extinct radiation in NIR region increased from 0.17 to 0.34 and 0.5 to 0.13 for thick and thin samples respectively with TEOS plasma treatment.

The pristine and oxygen plasma pretreated fabric surfaces with the optimized level of electrospinning and TEOS plasma treatments were examined with XPS to determine the effect of various surface treatments. From the XPS data (FIG. 1.8A-H), the pursued modifications significantly increased the elemental percentage of B, N, and Si on the fabric surface. This effect was predominantly shown by the oxygen plasma pretreated fabric substrates. The elemental analysis on the oxygen plasma pretreated fabric revealed that the amount of B increased by 1.6% and N by 1.1% with PET-BN ES nanofiber deposition. Whereas the amount of B and N increased respectively by 1.0% and 1.1% on the pristine fabric. With 10 minutes of silane plasma treatment, the Si content increased by 18.9% and the B and N decreased by 0.3% and 0.1% respectively on the oxygen plasma pretreated fabric. On the pristine sample, the Si content increased by 18.5% and the B and N decreased by 0.2% each. This ensures the incorporation of BNNPs with PET ES fibers and SiNps deposition on the surface. The effect of fabric surface activation targeted via oxygen plasma pretreatment was predominantly seen in the elemental percentage change with modified water-soaked substrates. The oxygen plasma-pretreated fabric coatings were expected to be more stable, and the data better corroborated the argument. Because the loss percentages of B, N, and Si were more with the pristine fabric. The percentage loss was 0.2%, 0.3%, and 0.2% respectively for Si, B, and N on the oxygen plasma-pretreated fabric, whereas those were 6.7%, 0.3%, and 0.2% on the pristine fabric. The percentage loss of elements, lack of coating stability, and deteriorated thermal regulation potential of the coating with water soaking better substantiate the claim of improved surface activation of fabric fibers with oxygen plasma treatment. The high-resolution spectra of Si on TEOS plasma-pretreated PET-BN ES fibers revealed the presence of Si in various environments such as Si—C at 102.0 eV, Si—O—C/SiOx at 102.7 eV, and SiO2 at 103.0 eV.

### 3. CONCLUSION

Personal thermal comfort is one of the major requirements of the world. The proposed strategy of designing thermal regulatory textiles is a facile, novel, and efficient method to modify existing fabric materials to improve their thermal regulation potential. The method comprised of a combination strategy of electrospinning and plasma surface modification techniques. The ES non-woven nanofibers of BN-PET were laid on the oxygen plasma pretreated fabric substrate as a thin film of uniform thickness which ensures the distribution of BNNps and coating stability in water. The thermal regulation potential of the nanofibers was augmented with SiNps deposition via LTP processing, which is viable for thermally sensitive materials. The proposed work will be a better improvement to the existing thermal regulation textile materials system to ensure personal thermal comfort. We proposed a mechanism to incorporate the thermal regulation potential to the fabric material regardless of its nature whereas most of the previous works were focused on the development of a new thermal regulative textile material. The thermal regulation potential of both SiNps and BNNps were successively combined in this work without the assistance of any wet chemical methods which was not attempted previously by any researchers. Thereby the thermal regulation efficiency improved significantly by the proposed method. Since this is an additional coating on the fabric substrate, the thermal regulation efficiency with washing was examined and elucidated as stable up to 5-8 washes. But it would reduce with increased washing counts. This need to be optimized for long-term use. In real-life applications, it would be better to make double-layered clothing where the modified surfaces are in contact with each other and the regular surface with the user's body. Even if the Nps loss was insignificant, it would be better to avoid possible exposures. In summary, the proposed method of thermal regulation is an efficient, easy, cost-effective, green, and reliable technique compared to the existing methods.

### 4. EXPERIMENTAL

Oxygen gas used for the plasma treatment was purchased from Airgas Healthcare, (Birmingham, USA). The materials required for electrospinning, polyethylene terephthalate (PET) pellets, and BNNps powder were purchased from Fisher Scientific-Lab Equipment & Supplies. The solvent for electrospinning, 1,1,1,3,3,3-Hexafluoro-2-propanol (HFIP) (CAS: 920-66-1, MW: 168.04) was purchased from Oakwood chemicals. The tetraethyl ortho silicate, 98% (TEOS) (CAS: 78-10-4, MW: 208.33) was bought from Across organics for plasma surface modification.

### 4.1 Substrate Preparation and Modification

Commercial cotton fabric was the substrate used for developing thermal regulative properties as a proof of concept.

### 4.1.1 Plasma Pretreatment

The fabric samples were pretreated with oxygen plasma for surface activation. Efficiency of oxygen plasma in surface activation of fiber was reported⁵⁴. The plasma chamber required a low working pressure ranging from 500 mTorr to 1000 m Torr to generate the plasma discharge. This was achieved by using a vacuum pump attached to the plasma system. The inlet port was connected to an oxygen cylinder to introduce the gas metered at a 30 SCCM flow rate. Plasma modification was performed using 13.56 MHz, 45 W (high) radio frequency (RF) power with a Harrick Plasma PDC-001-HP Cleaner System. The fabric samples were horizontally place in the chamber on a glass plate and oxygen plasma treatment was carried for 10 minutes.

### 4.1.2 Electrospinning

A 20 mL of 15% wt/vol PET polymer solution was prepared by dissolving PET in HFIP. PET pellets were stirred in HFIP for 72 h at room temperature. The solution was mixed with BNNps to get a 0.17% wt/wt BN-PET solution and stirred for 10 hrs for uniform dispersion. The PET solution concentration and amount of BNNps were optimized for a stable nanofiber layer on the substrate surface and improved thermal regulation potential. The parameter for the electrospinning process was set as follows: the applied voltage was 20 KV, needle to collector distance was maintained at 18 cm, and the flow rate was 1.0 mL/hr. The needle stage was moved back and forth at 50 mm/hr. The collector for the electrospinning process was a vertical static screen that was covered with aluminum foil, on top of which the fabric sample have been placed. The total volume of the BN-PET solution used for a 5 cm×5 cm sample was 1.0 mL. The electrospinning process maintained the flow rate by using Harvard PHD 2000 Advanced syringe pump. The samples were analyzed for their thermal regulation potential and morphology. A thin PET-BN ES non-woven nanofiber layer was made with 0.1 mL of 8% wt/vol PET in HFIP solution mixed with BNNps to get a 0.31% wt/wt BN-PET solution (S1) and was further analyzed with SEM to get the distribution of PET nanofibers and BNNps. 1.0 mL of S1 was spun and modified for thermal analysis with TEOS plasma surface treatment.

### 4.1.3 Plasma-Assisted Deposition of SiNps

The electrospun layers were further modified with SiNps deposition using TEOS plasma. The working pressure for the plasma chamber was maintained at a range of 500 m Torr to 1000 m Torr in the Harrick plasma system. The electrospun-coated fabric was placed in the chamber with TEOS plasma formation using 0.5 mL of the precursor for 10 minutes with a controlled airflow of 25 SCCM. The volume of TEOS and duration of plasma surface treatment were optimized after trials. The inlet port was set to introduce ambient atmosphere metered at a 30 SCCM flow rate.

### 4.2 Characterization of the Modified Fabric

Fourier Transform InfraRed (FTIR) spectroscopy, Scanning Electron Microscopy (SEM), and X-ray Photoelectron Spectroscopy (XPS) were employed in elucidating the surface morphological and chemical properties in the plasma surface modified fabric and electrospun nanofibers.

The change in surface energy of the fabric samples with oxygen plasma treatment was analyzed using contact angle measurements. In this case, the static contact angle measurements were pursued with glycerol using sessile drop method at room temperature⁵⁵. The contact angle values on the surface of fabric samples were recorded in 3 s, 10 s, and 20 s time intervals and accurately measured using image J software. Using the contact angle measurements, the surface energy change with oxygen plasma treatments was estimated using Owen & Wendt equation⁵⁶. The Nicolet 4700 FTIR spectrometer with ATR mode was used to acquire IR absorption spectra (400 to 4000 cm⁻¹) of the pristine and plasma surface modified fabric samples at a scan rate of 128 scans per second with a resolution of 4. The structure and morphology of the electrospun nanofibers of BN incorporated PET on the pristine and plasma-pretreated fabric before and after silane plasma treatment were characterized using SEM. The sputter-coating was performed with Au—Pd and observed using an FE-SEM (FEI, Hillsboro) at 20 kV and imaging was performed at different magnifications. Transmission electron microscopy (TEM) imaging of the BNNps and SiNps was carried out using a Tecnai Spirit T12 TEM (Thermo Fisher, formerly FEI) with an operating voltage range of 20-120 kV. XPS spectra recording was performed with PHI 5000 Versaprobe imaging XPS. The X-ray beam of this instrument was a focused, monochromatic, Al K-alpha source (E=1486.6 eV) at 25 W with a 100 μm spot size. An argon ion gun was utilized to control any charge in the spectra by neutralizing the charge. Multipak v9.0 programming was used for the analysis. The thermal regulation potential of the modified fabric was examined using a FLIR TG165 imaging IR thermometer. A hot plate maintained at 45° C. was used as the thermal source. The distance between the hot plate and fabric was maintained at 15 in and the fabric to the camera was 10 in.

White-light extinction spectroscopy was used to investigate the optical properties of our modified fabrics. A stabilized tungsten-halogen light source (Thorlabs SLS201L) was collimated and provided Kohler illumination onto our samples. The transmitted light was collected using 100×, NA 0.7, and spatially filtered using an iris diaphragm at the focus of the image formation plane. The filtered, collimated light was then focused onto a fiber-coupled spectrometer (Avantes StarLine) using a 10-cm focal lens where the intensity of the transmitted light was measured as a function of the detected wavelength in a range from 400 nm to 1100 nm. The samples were translated using the 3-Axis closed-loop piezo NanoMax stage and an XY translation mount for rectangular optics (Thorlabs XYF1), for fine and coarse position adjustments.

### 5. REFERENCES

(1) Goldstein, E. A.; Raman, A. P.; Fan, S. Sub-ambient non-evaporative fluid cooling with the sky. Nature Energy 2017, 2 (9), 17143. DOI: 10.1038/nenergy.2017.143.
(2) Liu, S.; Wang, Z.; Schiavon, S.; He, Y.; Luo, M.; Zhang, H.; Arens, E. Predicted percentage dissatisfied with vertical temperature gradient. Energy and Buildings 2020, 220, 110085. DOI: https://doi.org/10.1016/j.enbuild.2020.110085.
(3) Axelrod, Y. K.; Diringer, M. N. Temperature Management in Acute Neurologic Disorders. Neurologic Clinics 2008, 26 (2), 585-603. DOI: https://doi.org/10.1016/j.ncl.2008.02.005.
(4) Holman, D. M.; Ding, H.; Guy, G. P., Jr.; Watson, M.; Hartman, A. M.; Perna, F. M. Prevalence of Sun Protection Use and Sunburn and Association of Demographic and Behavioral Characteristics With Sunburn Among US Adults. JAMA Dermatol 2018, 154 (5), 561-568. DOI: 10.1001/jamadermatol.2018.0028 From NLM.
(5) Wu, S.; Cho, E.; Li, W. Q.; Weinstock, M. A.; Han, J.; Qureshi, A. A. History of Severe Sunburn and Risk of Skin Cancer Among Women and Men in 2 Prospective Cohort Studies. Am J Epidemiol 2016, 183 (9), 824-833. DOI: 10.1093/aje/kwv282 From NLM.
(6) Paulson, K. G.; Gupta, D.; Kim, T. S.; Veatch, J. R.; Byrd, D. R.; Bhatia, S.; Wojcik, K.; Chapuis, A. G.; Thompson, J. A.; Madeleine, M. M.; et al. Age-Specific Incidence of Melanoma in the United States. JAMA Dermatol 2020, 156 (1), 57-64. DOI: 10.1001/jamadermatol.2019.3353 From NLM.
(7) Brown, D. J. A.; Brugger, H.; Boyd, J.; Paal, P. Accidental Hypothermia. New England Journal of Medicine 2012, 367 (20), 1930-1938. DOI: 10.1056/NEJMra1114208.
(8) Somanathan, E.; Somanathan, R.; Sudarshan, A.; Tewari, M. The Impact of Temperature on Productivity and Labor Supply: Evidence from Indian Manufacturing. Journal of Political Economy 2021, 129 (6), 1797-1827. DOI: 10.1086/713733.
(9) Hsiang, S. M.; Burke, M.; Miguel, E. Quantifying the Influence of Climate on Human Conflict. Science 2013, 341 (6151), 1235367. DOI: doi: 10.1126/science. 1235367.
(10) Dell, M.; Jones, B. F.; Olken, B. A. What Do We Learn from the Weather? The New Climate-Economy Literature. Journal of Economic Literature 2014, 52 (3), 740-798. DOI: 10.1257/jel.52.3.740.
(11) Lingua, C.; Becchio, C.; Bottero, M.; Corgnati, S.; Dell'Anna, F.; Fabi, V. Energy and Economic Evaluation of Thermal Comfort. The Case Study of the Hotel Residence L'Orologio; 2020. DOI: 10.26868/25222708.2019.210687.
(12) Niemann, P.; Schmitz, G. Impacts of occupancy on energy demand and thermal comfort for a large-sized administration building. Building and Environment 2020, 182, 107027. DOI: https://doi.org/10.1016/j.buildenv.2020.107027.
(13) Kim, J.; Schiavon, S.; Brager, G. Personal comfort models-A new paradigm in thermal comfort for occupant-centric environmental control. Building and Environment 2018, 132, 114-124. DOI: https://doi.org/10.1016/j.buildenv.2018.01.023.
(14) Costanzo, V.; Evola, G.; Marletta, L.; Nocera, F. The effectiveness of phase change materials in relation to summer thermal comfort in air-conditioned office buildings. Building Simulation 2018, 11 (6), 1145-1161. DOI: 10.1007/s12273-018-0468-2.
(15) Baji, A.; Agarwal, K.; Oopath, S. V. Emerging Developments in the Use of Electrospun Fibers and Membranes for Protective Clothing Applications. Polymers 2020, 12 (2), 492.
(16) Shi, S.; Si, Y.; Han, Y.; Wu, T.; Iqbal, M. I.; Fei, B.; Li, R. K. Y.; Hu, J.; Qu, J. Recent Progress in Protective Membranes Fabricated via Electrospinning: Advanced Materials, Biomimetic Structures, and Functional Applications. Advanced Materials 2022, 34 (17), 2107938. DOI: https://doi.org/10.1002/adma.202107938.
(17) Lee, J. A.; Krogman, K. C.; Ma, M.; Hill, R. M.; Hammond, P. T.; Rutledge, G. C. Highly Reactive Multilayer-Assembled TiO2 Coating on Electrospun Polymer Nanofibers. Advanced Materials 2009, 21 (12), 1252-1256. DOI: https://doi.org/10.1002/adma.200802458.
(18) Shaulsky, E.; Nejati, S.; Boo, C.; Perreault, F.; Osuji, C. O.; Elimelech, M. Post-fabrication modification of electrospun nanofiber mats with polymer coating for membrane distillation applications. Journal of Membrane Science 2017, 530, 158-165. DOI: https://doi.org/10.1016/j.memsci.2017.02.025.
(19) Ribitsch, D.; Yebra, A. O.; Zitzenbacher, S.; Wu, J.; Nowitsch, S.; Steinkellner, G.; Greimel, K.; Doliska, A.; Oberdorfer, G.; Gruber, C. C.; et al. Fusion of Binding Domains to Thermobifida cellulosilytica Cutinase to Tune Sorption Characteristics and Enhancing PET Hydrolysis. Biomacromolecules 2013, 14 (6), 1769-1776. DOI: 10.1021/bm400140u.
(20) Gao, D.; Yang, D.-f.; Cui, H.-s.; Huang, T.-t.; Lin, J.-x. Supercritical Carbon

Dioxide Dyeing for PET and Cotton Fabric with Synthesized Dyes by a Modified Apparatus. ACS Sustainable Chemistry & Engineering 2015, 3 (4), 668-674. DOI: 10.1021/sc500844d.
(21) Ibrahim, N. A.; Eid, B. M.; Khalil, H. M.; Almetwally, A. A. A new approach for durable multifunctional coating of PET fabric. Applied Surface Science 2018, 448, 95-103. DOI: https://doi.org/10.1016/j.apsusc.2018.04.022.
(22) Jelil, R. A. A review of low-temperature plasma treatment of textile materials. Journal of Materials Science 2015, 50 (18), 5913-5943. DOI: 10.1007/s10853-015-9152-4.
(23) Thirumdas, R.; Sarangapani, C.; Annapure, U. S. Cold Plasma: A novel Non-Thermal Technology for Food Processing. Food Biophysics 2015, 10 (1), 1-11. DOI: 10.1007/s11483-014-9382-z.
(24) Vijayan, V. M.; Tucker, B. S.; Dimble, P. S.; Vohra, Y. K.; Thomas, V. Dusty-Plasma-Assisted Synthesis of Silica Nanoparticles for in Situ Surface Modification of 3D-Printed Polymer Scaffolds. ACS Applied Nano Materials 2020, 3 (8), 7392-7396. DOI: 10.1021/acsanm.0c01734.
(25) Sriramulu, D.; Reed, E. L.; Annamalai, M.; Venkatesan, T. V.; Valiyaveettil, S. Synthesis and Characterization of Superhydrophobic, Self-cleaning NIR-reflective Silica Nanoparticles. Scientific Reports 2016, 6 (1), 35993. DOI: 10.1038/srep35993.
(26) Zhang, Q.; Xue, T.; Tian, J.; Yang, Y.; Fan, W.; Liu, T. Polyimide/boron nitride composite aerogel fiber-based phase-changeable textile for intelligent personal thermoregulation. Composites Science and Technology 2022, 226, 109541. DOI: https://doi.org/10.1016/j.compscitech.2022.109541.
(27) Nine, M. J.; Hee, A. C.; Tung, T. T.; Hassan, K.; Losic, D. Cross-overlapped flat-silver/hexagonal boron nitride for translucent heat-reflective coatings. Applied Materials Today 2020, 20, 100764. DOI: https://doi.org/10.1016/j.apmt.2020.100764.
(28) Li, S.; Wang, H.; Mao, H.; Li, L.; Shi, H. Enhanced thermal management performance of comb-like polymer/boron nitride composite phase change materials for the thermoregulated fabric application. Journal of Energy Storage 2021, 40, 102826. DOI: https://doi.org/10.1016/j.est.2021.102826.
(29) Candadai, A. A.; Nadler, E. J.; Burke, J. S.; Weibel, J. A.; Marconnet, A. M. Thermal and mechanical characterization of high performance polymer fabrics for applications in wearable devices. Scientific Reports 2021, 11 (1), 8705. DOI: 10.1038/s41598-021-87957-7.
(30) Ruiz-Calleja, T.; Bonet-Aracil, M.; Gisbert-Payá, J.; Bou-Belda, E. Analysis of the influence of graphene and phase change microcapsules on thermal behavior of cellulosic fabrics. Materials Today Communications 2020, 25, 101557. DOI: https://doi.org/10.1016/j.mtcomm.2020.101557.
(31) Tong, J.; Li, L. Thermal Regulation of Electrically Conducting Fabrics. In Handbook of Smart Textiles, Tao, X. Ed.; Springer Singapore, 2015; pp 689-718.
(32) Karaszewska, A.; Kamińska, I.; Nejman, A.; Gajdzicki, B.; Fortuniak, W.; Chojnowski, J.; Slomkowski, S.; Sowinski, P. Thermal-regulation of nonwoven fabrics by microcapsules of n-eicosane coated with a polysiloxane elastomer. Materials Chemistry and Physics 2019, 226, 204-213. DOI: https://doi.org/10.1016/j.matchemphys.2019.01.029.
(33) Gao, T.; Yang, Z.; Chen, C.; Li, Y.; Fu, K.; Dai, J.; Hitz, E. M.; Xie, H.; Liu, B.; Song, J.; et al. Three-Dimensional Printed Thermal Regulation Textiles. ACS Nano 2017, 11 (11), 11513-11520. DOI: 10.1021/acsnano.7b06295.
(34) Cai, L.; Peng, Y.; Xu, J.; Zhou, C.; Zhou, C.; Wu, P.; Lin, D.; Fan, S.; Cui, Y. Temperature Regulation in Colored Infrared-Transparent Polyethylene Textiles. Joule 2019, 3 (6), 1478-1486. DOI: https://doi.org/10.1016/j.joule.2019.03.015.
(35) Mohamed, A. L.; El-Naggar, M. E.; Shaheen, T. I.; Hassabo, A. G. Laminating of chemically modified silan based nanosols for advanced functionalization of cotton textiles. International Journal of Biological Macromolecules 2017, 95, 429-437. DOI: https://doi.org/10.1016/j.ijbiomac.2016.10.082.
(36) Mui, T. S. M.; Mota, R. P.; Quade, A.; Hein, L. R. d. O.; Kostov, K. G. Uniform surface modification of polyethylene terephthalate (PET) by atmospheric pressure plasma jet with a horn-like nozzle. Surface and Coatings Technology 2018, 352, 338-347. DOI: https://doi.org/10.1016/j.surfcoat.2018.08.014.
(37) Zille, A.; Oliveira, F. R.; Souto, A. P. Plasma Treatment in Textile Industry. Plasma Processes and Polymers 2015, 12 (2), 98-131. DOI: https://doi.org/10.1002/ppap.201400052.
(38) Nemani, S. K.; Annavarapu, R. K.; Mohammadian, B.; Raiyan, A.; Heil, J.; Haque, M. A.; Abdelaal, A.; Sojoudi, H. Surface Modification of Polymers: Methods and Applications. Advanced Materials Interfaces 2018, 5 (24), 1801247. DOI: https://doi.org/10.1002/admi.201801247.
(39) Bazaka, K.; Jacob, M. V.; Chrzanowski, W.; Ostrikov, K. Anti-bacterial surfaces: natural agents, mechanisms of action, and plasma surface modification. RSC Advances 2015, 5 (60), 48739-48759, 10.1039/C4RA17244B. DOI: 10.1039/C4RA17244B.
(40) Mrsic, I.; Bauerle, T.; Ulitzsch, S.; Lorenz, G.; Rebner, K.; Kandelbauer, A.; Chassé, T. Oxygen plasma surface treatment of polymer films—Pellethane 55DE and EPR-g-VTMS. Applied Surface Science 2021, 536, 147782. DOI: https://doi.org/10.1016/j.apsusc.2020.147782.
(41) Mozetič, M. Plasma-Stimulated Super-Hydrophilic Surface Finish of Polymers. Polymers 2020, 12 (11), 2498.
(42) Holc, M.; Zaplotnik, R.; Mozetic, M.; Vesel, A. Surface Modification and Aging of Polyacrylonitrile Butadiene Styrene Polymer Induced by Treatment in RF Oxygen Plasma. IEEE Transactions on Plasma Science 2018, 46 (10), 3669-3676. DOI: 10.1109/TPS.2018.2855808.
(43) Sundriyal, P.; Sahu, M.; Prakash, O.; Bhattacharya, S. Long-term surface modification of PEEK polymer using plasma and PEG silane treatment. Surfaces and Interfaces 2021, 25, 101253. DOI: https://doi.org/10.1016/j.surfin.2021.101253.
(44) Niemczyk-Soczynska, B.; Gradys, A.; Sajkiewicz, P. Hydrophilic Surface Functionalization of Electrospun Nanofibrous Scaffolds in Tissue Engineering. Polymers 2020, 12 (11), 2636.
(45) Vesel, A.; Mozetic, M. Surface modification and ageing of PMMA polymer by oxygen plasma treatment. Vacuum 2012, 86 (6), 634-637. DOI: https://doi.org/10.1016/j.vacuum.2011.07.005.
(46) Wei, Z.; Gu, J.; Ye, Y.; Fang, M.; Lang, J.; Yang, D.; Pan, Z. Biodegradable poly(butylene succinate) nanofibrous membrane treated with oxygen plasma for superhydrophilicity. Surface and Coatings Technology 2020, 381, 125147. DOI: https://doi.org/10.1016/j.surfcoat.2019.125147.
(47) Cvelbar, U.; Junkar, I.; Modic, M. Hemocompatible Poly(ethylene terephthalate) Polymer Modified via Reactive Plasma Treatment. Japanese Journal of Applied Physics 2011, 50 (8), 08JF02. DOI: 10.1143/jap.50.08jf02.
(48) Ricard, A. Reactive plasmas; Société française du vide, 1996.
(49) Morent, R.; De Geyter, N.; Leys, C.; Gengembre, L.; Payen, E. Surface Modification of Non-woven Textiles using a Dielectric Barrier Discharge Operating in Air, Helium and Argon at Medium Pressure. Textile Research Journal 2007, 77 (7), 471-488. DOI: 10.1177/0040517507080616 (accessed 2021 Jun. 13).
(50) Heriberto, R.-T.; Graciela, M.; Daniel, G. Electrospinning and Electrospraying Techniques for Designing Antimicrobial Polymeric Biocomposite Mats. In Nanofiber Research, Mohammed Muzibur, R., Abdullah, M. A. Eds.; IntechOpen, 2016; p Ch. 5.
(51) Kim, J. Y.; Lee, S. J.; Baik, G. Y.; Hong, J. G. Viscosity Effect on the Electrospray Characteristics of Droplet Size and Distribution. ACS Omega 2021, 6 (44), 29724-29734. DOI: 10.1021/acsomega.1c04119.
(52) Higashi, S.; Hirai, T.; Matsubara, M.; Yoshida, H.; Beniya, A. Dynamic viscosity recovery of electrospinning solution for stabilizing elongated ultrafine polymer nanofiber by TEMPO-CNF. Scientific Reports 2020, 10 (1), 13427. DOI: 10.1038/s41598-020-69136-2.
(53) Cramariuc, B.; Cramariuc, R.; Scarlet, R.; Manea, L. R.; Lupu, I. G.; Cramariuc, O. Fiber diameter in electrospinning process. Journal of Electrostatics 2013, 71 (3), 189-198. DOI: https://doi.org/10.1016/j.elstat.2012.12.018.
(54) Correia, D. M.; Ribeiro, C.; Sencadas, V.; Botelho, G.; Carabineiro, S. A. C.; Ribelles, J. L. G.; Lanceros-Méndez, S. Influence of oxygen plasma treatment parameters on poly(vinylidene fluoride) electrospun fiber mats wettability. Progress in Organic Coatings 2015, 85, 151-158. DOI: https://doi.org/10.1016/j.porgcoat.2015.03.019.
(55) Tucker, B. S.; Baker, P. A.; Xu, K. G.; Vohra, Y. K.; Thomas, V. Atmospheric pressure plasma jet: A facile method to modify the intimal surface of polymeric tubular conduits. Journal of Vacuum Science & Technology A 2018, 36 (4), 04F404. DOI: 10.1116/1.5023259.
(56) Owens, D. K.; Wendt, R. C. Estimation of the surface free energy of polymers. Journal of Applied Polymer Science 1969, 13 (8), 1741-1747. DOI: https://doi.org/10.1002/app.1969.070130815.

### Example 2

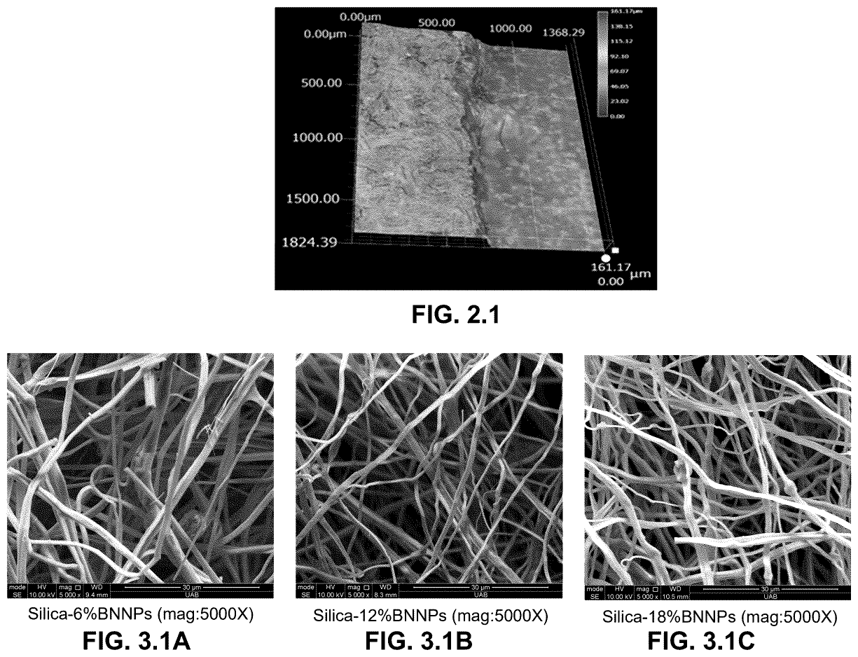

This study is directed to establishing LTP corona as a process method to develop thermoregulative textile for workers' safety. During the first part of this award, we established a quantitative method to access the temperature reduction (reflection) and to the initial selection of the nanoparticles to be incorporated to the textile fabric for thermos-regulation properties. We have used various nanoparticles (SiO2, TiO2, Al2O3, BN, and HNT) for the experimentation. In atypical experiments, particles 1% wt/vol mixed with polymer, poly vinyl alcohol or poly vinyl pyrrolidone and electro-sprayed/spun onto two types of textiles (cotton and polyester). Our preliminary studies showed effective infrared-reflection by boron nitride nanoparticle incorporated cotton-textile and polyester than nylon. The textile fabrics were air-plasma treated for effective wettability of the polymer/nanoparticle formulation. FIG. 2.1 shows the coating thickness and Table 1 show the preliminary data with electrospun PET onto cotton.

TABLE 1
Fabric substrate (PET) with and without oxygen
plasma activation on the thermal control.

| | | | Effective Temperature at Different | | | | |
|---|---|---|---|---|---|---|---|
| | | | Time Intervals (° C.) | | | | |
| Sample | | | 10 s | 20 s | 30 s | 40 s | 50 s |
| 8% wt/vol PET/HFIP | No O₂ | Pristine | 22.6 | 28.3 | 35.4 | 35.5 | 35.5 |
| 0.31 wt/wt BN/PET | plasma | ES | 20.3 | 21.1 | 22.6 | 22.6 | 22.6 |
| | pretreatment | ES + PL | 18.7 | 19.4 | 19.6 | 19.6 | 19.6 |
| | | ES + PL + WD | 18.8 | 20.1 | 22.4 | 22.4 | 22.4 |
| 8% wt/vol PET/HFIP | With O₂ | Pristine | 22.3 | 28.0 | 34.7 | 34.7 | 34.7 |
| 0.31 wt/wt BN/PET | plasma | ES | 18.9 | 19.6 | 20.1 | 20.1 | 20.1 |
| | pretreatment | ES + PL | 18.3 | 18.5 | 18.7 | 18.8 | 18.8 |
| | | ES + PL + WD | 18.4 | 18.8 | 19.2 | 19.3 | 19.3 |

Results: A survey on various nanoparticles for effect thermoregulative properties were accomplished and hexagonal BN was found to be an optimized particle for incorporation in cotton/polyester fabric. Next stage is the design of the fabric with plasma processed SiO₂/TiO₂ layers of nanofiber matrix for scalable fabrication.

AC electrospinning can be conducted to industry scale up, where the properties of DC and AC spun fabrics for thermal conduction, mechanical and spectroscopic properties can be optimized for particular applications. Alternating current (AC) electrospinning provides large scale nanofibers with multiple times higher productivities (~1000 times) by simply replacing the direct current high voltage generator with an alternating current power supply.

### Example 3

Nanofiber including nanoparticles are described in Example 3. The polymer component is a 1:1 mixture of polyvinylpyrrolidone (PVP) and hydroxypropyl cellulose (HPC). The nanoparticles that are mixed with the polymer during electrospinning is silica nanoparticles, silica-boron nitride nanoparticles, titania, and titania-boron nitride nanoparticles, where the amount of boron nitride nanoparticles is about 6%, 12%, and 18% of the total amount of nanoparticles. The fibers were formed using AC electrospinning.

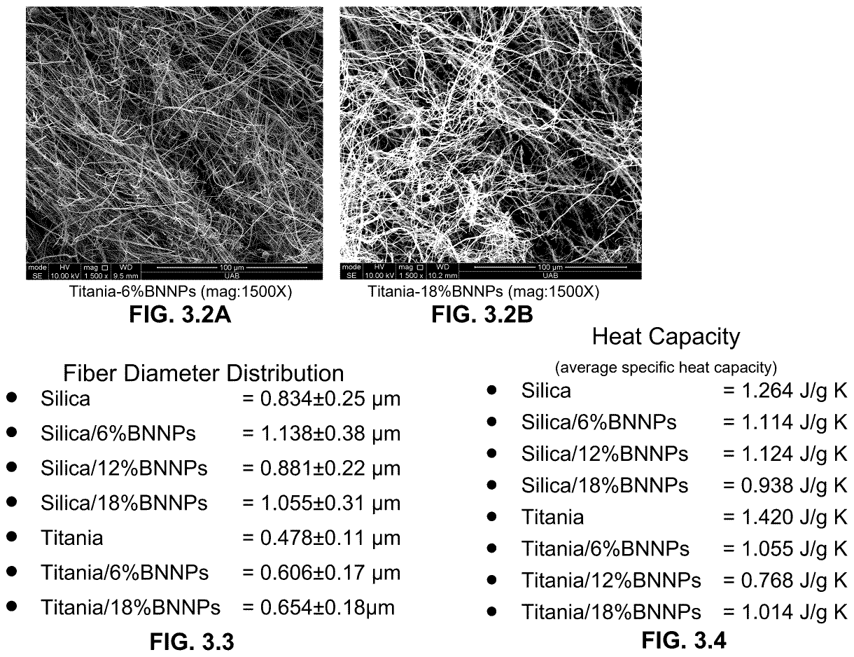

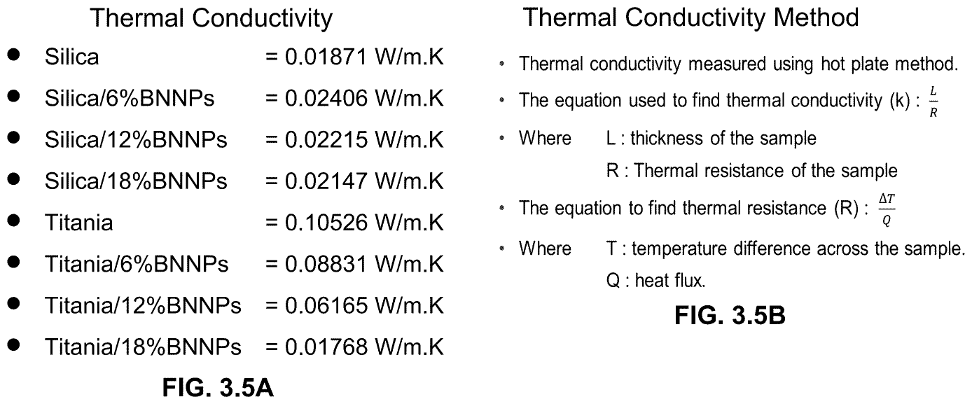

FIGS. 3.1A-3.1C illustrate SEM images of polymer fibers formed with silica and boron-nitride nanoparticles at various percentages. The fabricated mat shows moderately uniform morphology with fiber diameter distribution ranges from 500 nm to 1.5 micrometer. Addition of BN nanoparticles slightly increased the fiber diameter.

FIGS. 3.2A-3.2B illustrate SEM images of polymer fibers formed with titania and boron-nitride nanoparticles at various percentages. Electrospun titania/boron nitride fibers show relatively low structural integrity compared to silica counterparts.

FIG. 3.3 illustrates a table of the fiber diameter dimensions of the various fiber compositions. The small fiber diameter is favorable for thermal regulation because it alters heat transfer pathways, air tap between the fibers, and radiation interaction at the micro to nano scale.

FIG. 3.4 illustrates a table of the heat capacity of the various fiber compositions.

FIGS. 3.5A and 3.5B illustrates a table of the thermal conductivity of the various fiber compositions. Silica-based mats have lower thermal conductivity than silica-boron nitride compositions.

The AC electrospinning produced moderate uniform fiber mat. The modified fibers showed lower heat capacity (cₚ) compared to pristine fibers. The thermal conductivity of the silica is less than silica boron nitride nanoparticle mixtures. Relative to the silica and silica boron nitride nanoparticle mixtures, titania and titania boron nitride nanoparticle mixtures show lower structural stability. Of the various combinations tested, silica mixed with the polymer had the best thermos-regulative textile with high cₚ and lower thermal conductivity.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y” includes “about ‘x’ to about ‘y’”.

It should be emphasized that the above-described embodiments of the present disclosure are merely possible examples of implementations and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

What is claimed:

1. A textile, comprising:
an oxygen plasma-pretreated fabric substrate having a first pre-treated side of the fabric substrate, wherein the oxygen plasma-pretreated fabric substrate includes a layer of nanofibers and silicon oxide nanoparticles, wherein the nanofibers include nanoparticles and a polymer.

2. The textile of claim 1, wherein the layer of nanofibers is directly on the first pre-treated side of the fabric substrate and the silicon oxide nanoparticles are on the layer of nanofibers.

3. The textile of claim 1, further comprising a second substrate, wherein the second substrate is disposed onto the layer of nanofibers and silicon oxide nanoparticles, wherein the layer of nanofibers and silicon oxide nanoparticles is positioned between the oxygen plasma-pretreated fabric substrate and the second substrate.

4. The textile of claim 1, wherein the nanofibers comprise the polymer selected from polyethylene terephthalate (PET), polyamide, polytetrafluoroethylene, cotton, polyurethanes, polyesters, polyvinylpyrrolidone (PVP), hydroxylpropyl cellulose (HPC), combinations thereof, and derivatives of any one of these.

5. The textile of claim 1, wherein the nanofibers have a diameter of about 50 nm to 1 microns.

6. The textile of claim 1, wherein the nanoparticles are selected from boron nitride, silica, titania, glass micro balloons, or a combination thereof.

7. The textile of claim 1, wherein the boron nitride nanoparticles have a diameter of about 50 nm to 1 micron.

8. The textile of claim 1, wherein the silicon oxide nanoparticles have a diameter of about 100 nm to 1 micron.

9. The textile of claim 1, wherein the layer of nanofibers has a thickness of about 100 nm to 1 μm.

10. The textile of claim 1, wherein the textile is IR reflective.

11. The textile of claim 10, wherein the textile is 15° C. cooler than an untreated textile exposed to the same IR rays.

12. The textile of claim 1, wherein the textile is water resistant.

13. A method of making a textile, comprising:
pretreating a fabric substrate with a low-temperature plasma to form an oxygen plasma-pretreated fabric substrate, wherein the oxygen plasma-pretreated fabric substrate has a first pre-treated side of the fabric substrate, wherein the low-temperature plasma is at a temperature of about 25 to 35° C.;
electrospinning a nanofiber onto the surface of the first pre-treated side of the fabric substrate to form a layer of nanofibers; and
treating the first pre-treated side of the fabric substrate to form the layer of nanofibers with a tetraethoxy orthosilicate (TEOS), tetra methoxy silane, amino propyl silane, or tetra methyl silane or hydroxymethyl silane plasma to form silicon oxide nanoparticles on the layer of nanofibers.

14. The method of claim 13, wherein the electrospinning is one of AC electrospinning, DC electrospinning, Force-spinning, melt electrospinning, or solution electrospinning.

15. The method of claim 13, wherein the pretreating is performed for about 5 to 15 minutes.

16. The method of claim 13, wherein the treating is performed for about 5 to 15 minutes.

17. The method of claim 13, further comprising disposing a second substrate onto the silicon oxide nanoparticles.

18. A method of making a textile, comprising:
pretreating a fabric substrate with a low-temperature plasma to form an oxygen plasma-pretreated fabric substrate, wherein the oxygen plasma-pretreated fabric substrate has a first pre-treated side of the fabric substrate, wherein the low-temperature plasma is at a temperature of about 25 to 35° C.;
treating the first pre-treated side of the fabric substrate with a tetraethoxy orthosilicate (TEOS), tetra methoxy silane, amino propyl silane, or tetra methyl silane or hydroxymethyl silane plasma to form silicon oxide nanoparticles on the pretreated fabric substrate; and
electrospinning a nanofiber onto the surface of the first pre-treated side of the fabric substrate and silicon oxide nanoparticles to form a layer of nanofibers.
